(19) United States
(12) Patent Application Publication
(10) Pub. No.: US 2003/0169966 A1
(43) Pub. Date: Sep. 11, 2003

(54) Optical fiber light source

(76) Inventor: Takashi Tokizaki, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/382,916

(22) Filed: Mar. 7, 2003

(30) Foreign Application Priority Data
Mar. 8, 2002 (JP) 2002-063158

(51) Int. Cl. G02B 6/26; G21G 4/00

(52) U.S. Cl. 385/31; 250/493.1

(57) ABSTRACT

An optical fiber light source comprises an optical fiber having at least one output end, an insulator surrounding the optical fiber, and a heater provided on the insulator, wherein output light is obtained from the at least one output end by heating the optical fiber in the insulator.

The optical fiber may be passed through the insulator two or more times.

### TECHNICAL FIELD OF THE INVENTION

This invention relates to an optical fiber light source, especially to a broadband light source for emitting output light having high spatial coherence.

### BACKGROUND OF THE INVENTION

As a light source of an inspection equipment for inspecting optical characteristics of optical parts used for optical communications, for example, a light source A shown in FIG. 5, or a light source B shown in FIG. 7A are used.

In FIG. 5, the light source A comprises a single mode optical fiber 1 for optical communication band, which outputs light output 6 from an output end 5, a core 7, a clad 10, a white light bulb 11 having a filament 11A wherein white light 12 is emitted from the white light bulb 11 and condensed by a condensing lens 13. In FIG. 7A, a fluorescent optical fiber 14 having a core 7A in which fluorescence atom is contained, and a single-mode optical fiber are welded together by a welding portion 15. In the core 7A of the fluorescent optical fiber 14, excitation light 17 is excited by a laser 16.

In the light sources A shown in FIG. 5, the white light 12 from the white light bulb 11 is concentrated at an end of the single-mode optical fiber 1 by the condensing lens 13 thereby the output light 6 of the light source can be obtained from the single-mode optical fiber 1.

Although in this type of system, the light source output having flat and wide spectrum of the white light bulb 11 can be obtained, light intensity is low as an optical fiber output.

As shown in FIG. 6, in the single-mode optical fiber 1, only light that enters within the incidence angle θₘₐₓ that is peculiar to the core 7 having a radius r can be propagated.

When ray tracing in the lens 13 is performed, it turns out that light emitted from the effective area of the radius R of filament 11A and emitted within the condensing angle θₘₐₓ enters to the core 7.

Between these parameters, there is the following relationship:

r tan θₘₐₓ=R tan Φₘₐₓ=Constant.

As R or θₘₐₓ become large, the amount of light increases. But if a radius R is large, the condensing angle θₘₐₓ will become small, and when condensing angle θₘₐₓ is large, a radius R becomes small. Therefore, there is no way to increase both simultaneously.

Therefore, the only way to increase the intensity of light is to raise a temperature of the filament, but that causes increase of light that does not enter into the core 7 if an electric bulb with high watt is used.

The conventional light source B shown in FIG. 7A is a light source from which high optical output with a spatial single mode is obtained.

In the core 7A, rare earth ion is contained to emit infrared rays, and the core 7A is made to emit light by optical excitation by another semiconductor laser 16 etc. from the outside of the fluorescent optical fiber 14. The excitation light 17 which is emitted from the core 7A of the fluorescent optical fiber 14 is directly propagated into the core 7 of the single mode optical fiber 1, and the light is taken out from the output end of the core 7.

Although a high output light can be obtained from this type of light source, the spectrum of the light is dependent on light-emitting atom that is contained in the core 7A, and, generally only a narrow spectrum is obtained.

FIG. 7B shows the spectrum in a typical product of a light source B.

A vertical axis represents light intensity per unit wavelength, and is expressed with the decibel which uses 1 mW intensity 1 mW as the standard.

The full width half maximum of the spectrum of a light source B is about 50 nm at most, and it is necessary to use a plurality of light sources B to cover a 1.3-1.6 μm (micrometers) communication band.

Moreover, there is a problem that both the light source A and the light source B are expensive.

In case of the light source A, it is necessary to precisely position a lens with micro-precision. In case of the light source B, a plurality of the special optical fibers in which the rare earth atom is doped are necessary.

### SUMMARY OF THE INVENTION

It is expected that the wavelength of 1.3-1.6 microns throughoutly used for optical communications.

Then, for development or inspection of the optical parts, a light source is required to have flat intensity throughout the wide wavelengths. Also, a spatial single mode usable for an optical fiber is needed. In recent years, it is expected that since much more communication capacity is required by the wavelength multiplex, the demand of such a light source will increase.

In view of foregoing, it is an object of the present invention to provide an optical fiber light source emitting light having uniform intensity throughout the wide wavelengths.

The present invention provides an optical fiber light source comprising an optical fiber having a core and at least one output end, and a heater which heats the optical fiber, wherein light output is obtained from the at least one output end by blackbody radiation generated in the core heated by the heater.

The optical fiber light source may have a first and second output ends, and a reflector may be provided on the first output end, and the output light is obtained from the second output end.

Thus, since the optical fiber light source according to the present invention has very simple structure, using a cheap optical fiber, an insulator pipe, and an electric heat wire, and further mass production is also easy.

The present invention further provide an optical fiber light source comprising an optical fiber having at least one output end, an insulator surrounding the optical fiber, and a heater provided on the insulator, wherein output light is obtained from the at least one output end by heating the optical fiber in the insulator.

The optical fiber light source may be passed through the insulator two or more times.

Thus, since it is possible to increase light intensity by lengthening a heating portion of an optical fiber, it is not necessary to choose an installation place and also it is easy to use.

Also, the optical fiber may have a first and second output ends, a reflector is provided on the first output end, and the output light is obtained from the second output end.

The present invention furthermore provide a method for generating output light, comprises the steps of heating a core of a optical fiber, generating blackbody radiation in the core, and outputting the output light from an output end.

### BRIEF DESCRIPTION OF THE DRAWINGS

The present inventions will now be described by way of example with reference to the following Figs. in which:

FIG. 1A is a schematic view of example of an optical fiber light source according to the present invention;

FIG. 1B is a schematic cross-sectional view of the optical fiber light source shown in FIG. 1A;

FIG. 1C is a schematic cross-sectional view of the optical fiber light source wherein a mirror is provided at the end of the optical fiber;

FIG. 2 is a graph showing the spectrum of output light which is measured by the photo-diode when the optical fiber light source shown in FIG. 1 is heated at 1200° C.;

FIG. 3 is a graph showing relationship between the output intensity and the length of the optical fiber shown in FIG. 1A;

FIG. 4 is a photograph showing a near-view microscopic image of an output end of the optical fiber shown in FIG. 1;

FIG. 5 is a conceptual diagram showing the conventional light source A;

FIG. 6 is a diagram explaining the characteristic of the conventional light source A;

FIG. 7A is a cross-sectional view showing the conventional light source B; and

FIG. 7B is a graph showing the spectrum of light output of the conventional optical fiber.

### DETAILED DESCRIPTION OF THE INVENTION

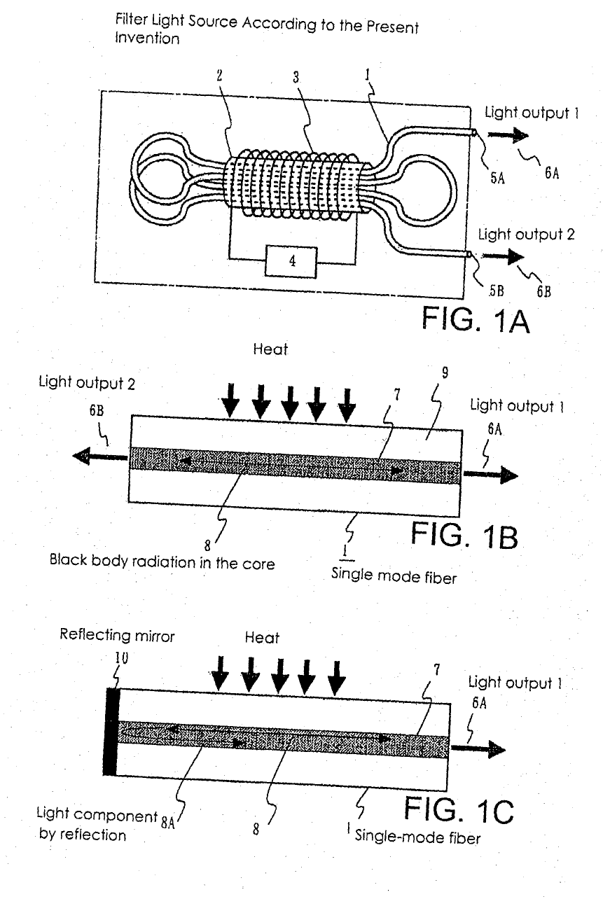

An example of the present invention is described based on FIGS. 1-3 below.

FIG. 1A is a schematic view of an example of an optical fiber light source according to the present invention.

The optical fiber light source comprises a single-mode optical fiber 1, an aluminum insulator pipe 2, an electrical heating wire 3 wound around the aluminum insulator pipe 2, and variable voltage power source 4 for controlling a temperature of the wire 3. In FIGS. 1A and 1B, numeral 8 denotes blackbody radiation in a quartz core 7.

The insulator pipe 2 is used for uniformly heating the single-mode optical fiber 1 and holding the highly heated optical fiber in a straight line shape. The optical fiber 1 can be directly heated by the heater such as the electrical heating wire.

The wire 3 is wound more than one time around the insulator pipe 2 and heats the insulator pipe uniformly. As a heating element, it is not limited to the electrical heating wire. Any heating element can be used.

The optical fiber 1 is passed through the inside of the isolator pipe 2, and output lights 6A and 6B are obtained from both the ends 5A and 5B of the single-mode optical fiber 1 by heating the optical fiber 1. The optical fiber may be passed through the isolator pipe more than one time as shown in FIG. 1A.

In this embodiment shown in FIG. 1A, a single-mode optical fiber for a 1.3 to 1.5 micron band, an aluminum insulator pipe with an 8 cm length and a 2 mm diameter, and a commercial 300W Nichrome line are used.

The principle of the light source of this invention is shown in FIG. 1B.

The blackbody radiation 8 which the core 7 emits is used as it is by heating the core 7 of the single mode optical fiber. Furthermore, as a feature of an optical fiber, the spatial mode is controlled automatically since only the blackbody radiation light which agrees in the perpendicular mode peculiar to the optical fiber among the lights generated within the 7 can be propagated, light other than components which disturbs spatial coherence, i.e., light other than the peculiar mode generated within the core 7, or light generated in the clad is not outputted.

Moreover, since the blackbody radiation is completely randomly emitted from each point of the heated core, the blackbody radiations do not interfere each other, and the output comprises the sum of the blackbody radiations emitted from each point.

Therefore, the optical intensity of optical fibers having low propagation loss (<dB/km), can be raised by sufficiently lengthening the portion to be heated.

As another advantage, since the optical fiber light source basically comprises only an optical fiber and a heater, it is possible to manufacture a very inexpensive light source.

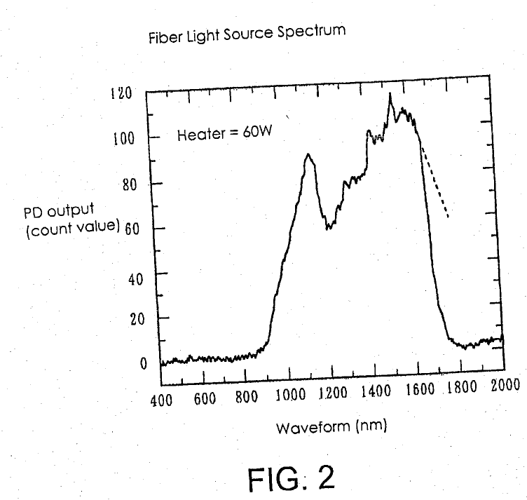

FIG. 2 is a graph showing the spectrum of output light which is measured by the photo-diode when the optical fiber light source shown in FIG. 1 is heated at 1200° C.

The vertical axis represents optical intensity per unit wavelength which is arbitrarily proportional to intensity.

Sixty (60) voltages are impressed to the wire 3, and the optical fiber temperature at this time was about 1200° C. by measurement of a thermocouple. Since an InGaAs photo-diode is used as a light receiver, the output with a wavelength of 900-1650 nm was observed.

The spectrum expected from blackbody radiation at 1200° C. has a peak at 2 μm (micrometers), and in a shortwave side, the intensity rapidly decreases and in a long wave side, it decreased gently.

In FIG. 2, the rapid attenuation in the long wave side is attributed to the sensitivity characteristic of the light receiver. In fact, it is expected that there is gentle attenuation exists. (Refer to a dotted line in FIG. 2.)

The level difference observed near 1200 nm is attributed to cutoff of the optical fiber. Since only a single mode (light) exists in the side of longer wavelengths than 1200 nm, and two or more modes exist in the side of shorter wavelength than 1200 nm, intensity is increased by the two ore more modes

From the above result, the light source shown in FIG. 1 is realizable as a single mode light source which can cover enough communication wavelength band, 1.3 to 1.5 microns.

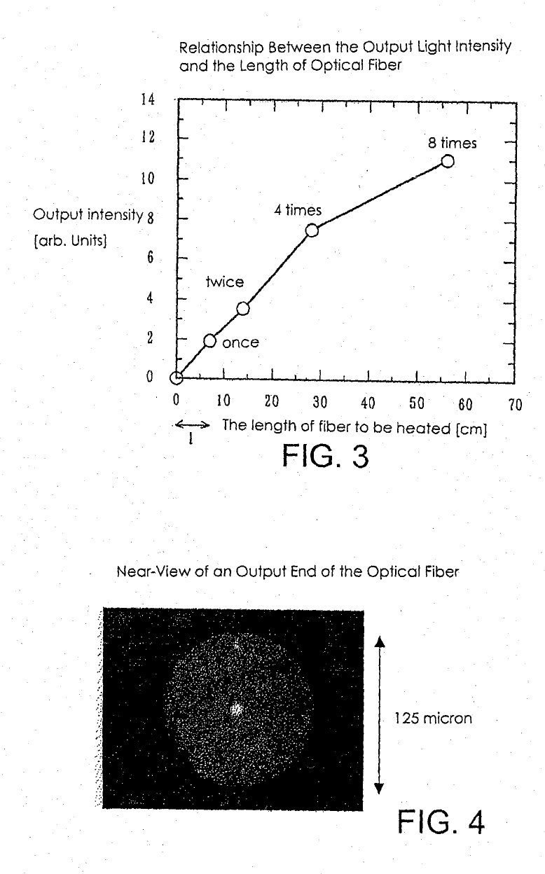

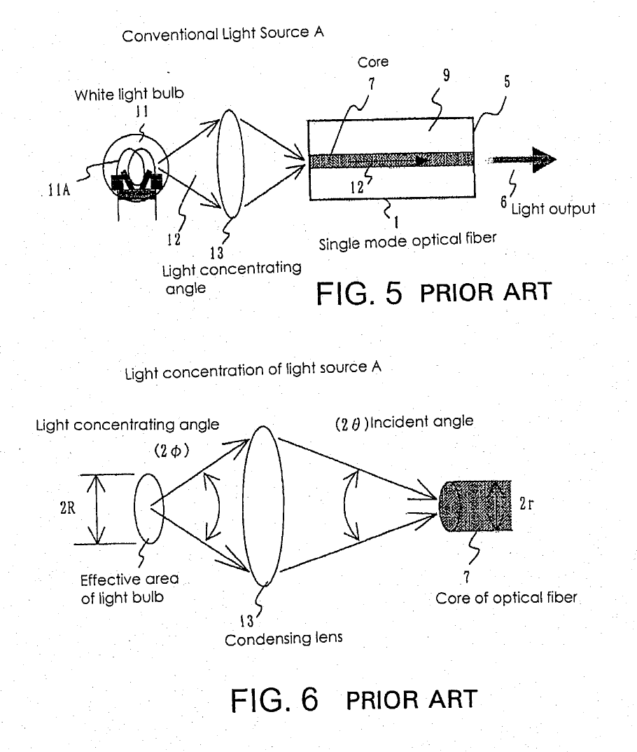

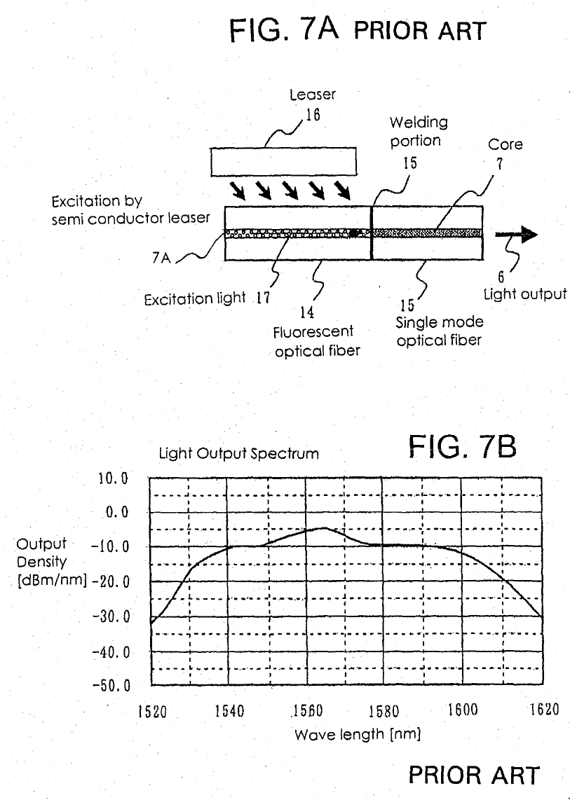

FIG. 3 is a graph showing relationship between the output intensity and the length of the optical fiber shown in FIG. 1.

As shown in FIG. 1A, the length to be heated can be easily changed by the number of times of passing the optical fiber in the insulator pipe 2.

The numbers shown in FIG. 3 represent the number of times of passing the optical fiber in the insulator pipe 2.

As shown in FIG. 3, it is shown that optical intensity is increasing almost in proportion to the length of the optical fiber to be heated.

In heating a 56 cm optical fiber at about 1200° C., optical intensity of 20 nW having 900-1650 nm wavelengths could be obtained from one of the output ends.

In the optical fiber, since the loss in 1.3-1.5 microns is 1 dB/km or less, if the fiber which is about 100 m long is heated, it will be possible to obtain the intensity of about 4 μW (microwatts).

Moreover, if light is reflected by a reflecting mirror stuck on one of the two output ends as shown in FIG. 1C, the output light intensity twice as high as that of the example shown in FIG. 1B can be obtained from the other output end.

FIG. 4 is a photograph showing a near-view microscopic image of output ends 5A and 5B of the optical fiber shown in FIG. 1

Uniform light is emitted from only the core (the center of) the optical fiber.

However, since a CCD camera is used for the photography, only about 1 μm (micrometer) light in the spectrum shown in FIG. 2 is caught. Therefore, the high order perpendicular mode structure in the doughnut shape originating in multi-mode structure can be observed slightly.

It is theoretically proved for many years that the wavelength in the spectrum peak of radiation light emitted from ideal blackbody of 1200° C. is 2 μm and that the full width half maximum thereof is 1 μm or more. Light which has such a spectrum also is obtained by heating the optical fiber.

Moreover, single-mode optical fibers made from quartz has enough heat resistance to maintain the shape thereof.

However, in prolonged use of hundreds of hours, although it is reported that a cross section of a core spreads a little by diffusion of the germanium doped in order to control the refractive index of a core portion, since light is taken out from the cooled single mode optical fiber portion, finally a perpendicular mode structure is chosen or converted in this portion, and the output light is outputted as a certain spatial mode. Therefore, it is expected that there is no influence on spatial coherence by changes with the passage of time.

In the optical communications field, in order to inspect the optical characteristic of optical parts, such as an optical fiber, the broadband light source having high spatial coherence is needed. The optical fiber light source according to this invention is optimal as a light source for such a use.

Moreover, a commercial optical fiber can also be used for the present invention.

The structure of the optical fiber light source used in the conventional technology is complicated. It requires time and effort for manufacture and cost much, although intensity of light obtained and the wavelength range are limited.

Since the optical fiber light source according to the present invention has very simple structure, using a cheap optical fiber, an insulator pipe, and an electric heat wire, it is cheap and further mass production is also easy. Moreover, since it is possible to increase light intensity by lengthening a heating portion of an optical fiber, it is not necessary to choose an installation place and also it is easy to use.

The disclosure of Japanese Patent Application No. 2002-63158 filed on Mar. 8, 2002 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. An Optical fiber light source comprising:
an optical fiber having a core and at least one output end; and
a heater which heats the optical fiber, wherein light output is obtained from the at least one output end by blackbody radiation generated in the core heated by the heater.

2. The optical fiber light source according to claim 1, wherein the optical fiber has a first and second output ends, a reflector is provided on the first output end, and the output light is obtained from the second output end.

3. An optical fiber light source comprising:
an optical fiber having at least one output end;
an insulator surrounding the optical fiber; and
a heater provided on the insulator, wherein output light is obtained from the at least one output end by heating the optical fiber in the insulator.

4. The optical fiber light source according to claim 3, wherein the optical fiber is passed through the insulator two or more times.

5. An optical fiber light source according to claim 4, wherein the optical fiber has a first and second output ends, a reflector is provided on the first output end, and the output light is obtained from the second output end.

6. A method for generating output light, comprises the following steps of:
heating a core of a optical fiber;
generating blackbody radiation in the core; and
outputting the output light from an output end.
